(19) United States
(12) Patent Application Publication
(10) Pub. No.: US 2026/0052064 A1
(43) Pub. Date: Feb. 19, 2026

(54) CONFIGURATION MANAGEMENT FOR TELEMETRY AGENTS

(71) Applicant: Cisco Technology, Inc., San Jose, CA (US)

(72) Inventors: Sanket Nalinkant Mehta, Bangalore (IN); Rahul Singh, Bangalore (IN); Sanjyoth Nandagudi Satish, Bangalore (IN); Ashutosh Goel, Bangalore (IN)

(21) Appl. No.: 18/800,341

(22) Filed: Aug. 12, 2024

(51) Int. Cl. H04L 41/0813; H04L 67/12

(52) U.S. Cl. CPC H04L 41/0813; H04L 67/12

(57) ABSTRACT

A method to enable dynamic configuration management of a telemetry agent. The method includes operating a telemetry agent on a host device, receiving, by the telemetry agent, configuration information, and updating, based on the configuration information, operational characteristics of the telemetry agent without restarting the telemetry agent. The telemetry agent may be an Open Telemetry agent.

### TECHNICAL FIELD

The present disclosure relates to network device and/or application monitoring using remote configurable agents.

### BACKGROUND

Information technology (IT) environments can include diverse types of data systems that store large amounts of diverse data types generated by numerous devices. For example, a big data ecosystem may include large databases, cloud computing services, and other data systems that store passively or actively generated data, including machine-generated data (“machine data”). Such machine data can include log data, performance data, diagnostic data, metrics, tracing data, counter values, or any other data that can be analyzed to diagnose equipment performance problems, monitor user interactions, and/or to derive other insights.

The large amount and diversity of data systems containing large amounts of structured, semi-structured, and unstructured data can be massive, and continues to grow rapidly. In an effort to monitor such data and the devices, equipment, and network resources used to generate it, remote telemetry agents are often hosted on selected devices to extract predetermined data that may be sent to a centralized location (e.g., a controller) that analyzes the extracted predetermined data and generates alerts, recommendations, automated controls, and other output that enable a network administrator or user to maintain or optimize the overall network or a given network device or piece of equipment.

### BRIEF DESCRIPTION OF THE DRAWINGS

FIG. 1 shows a portion of a network including network devices and a telemetry agent hosted by at least one of the network devices, according to an example embodiment.

FIG. 2 shows an architecture for a telemetry agent, according to an example embodiment.

FIG. 3 is a flowchart illustrating operations of the telemetry agent, according to an example embodiment.

FIG. 4 shows operations that use the Open Agent Management Protocol (OpAMP) to enable an Open Telemetry agent to be reconfigured from a remote server or controller, according to an example embodiment.

FIG. 5 is a flowchart depicting a series of steps that may be executed by the telemetry agent, according to an example embodiment.

FIG. 6 is a block diagram of a computing device that may be configured to host telemetry agent logic, and to perform techniques described herein, according to an example embodiment.

### DETAILED DESCRIPTION

### Overview

Presented herein is a method to enable dynamic configuration management of a telemetry agent. The method includes operating a telemetry agent on a host device, receiving, by the telemetry agent, configuration information, and updating, based on the configuration information, operational characteristics of the telemetry agent without restarting the telemetry agent. The telemetry agent may be an Open Telemetry (Otel) agent.

A device is also presented that includes an interface configured to enable network communications, a memory, and one or more processors coupled to the interface and the memory, and configured to: operate a telemetry agent on the device, receive, by the telemetry agent, configuration information, and update, based on the configuration information, operational characteristics of the telemetry agent without restarting the telemetry agent.

### EXAMPLE EMBODIMENTS

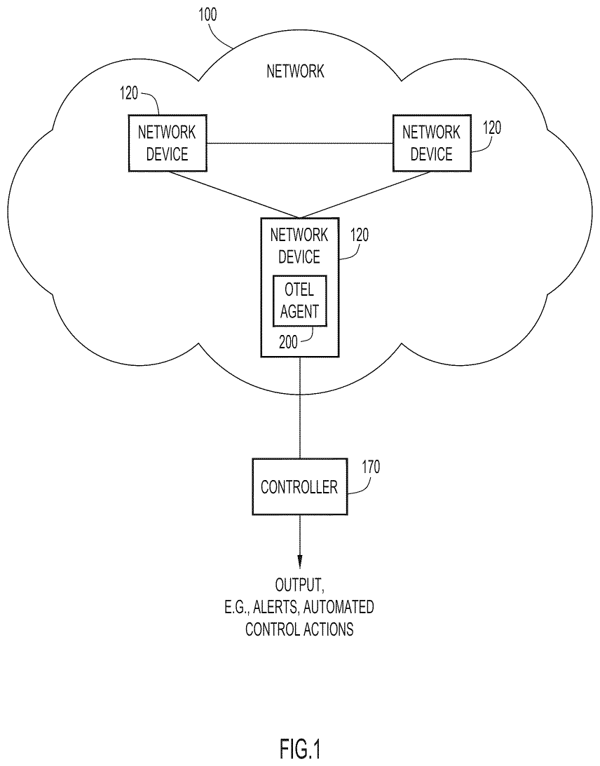

FIG. 1 shows a portion of a network 100 including network devices 120 and a telemetry agent, such as an Open Telemetry agent, or Otel agent 200, hosted by at least one of the network devices 120, according to an example embodiment. As depicted in the figure, the network devices 120 are networked together in, e.g., a cloud environment, or distributed across the Internet. At least one of the network devices 120 includes Otel agent 200 that is configured to extract predetermined data from network device 120 on which it is hosted, and to communicate the extracted predetermined data to a controller 170 or Otel compatible backend service (which could also be within network 100 or in another network altogether). As mentioned above, network 100 may generate large amounts of structured, semi-structured, and unstructured data. In an effort to monitor such data and the devices, equipment, and network resources used to generate it, Otel agent 200 may be hosted on selected network devices 120 to extract predetermined data that may be sent to a centralized location (such as controller 170) that is configured to analyze the predetermined data and, as appropriate, generate alerts, recommendations, automated control actions, and other output that enable a network administrator or user to maintain or optimize the overall network or a given network device 120 or other equipment.

In current implementations of Open Telemetry agents, configuration is managed only by environment variables (ENV vars) or by directly providing hardcoded values in the code. Such a design presents several drawbacks, however. For instance, a user cannot set the latest configuration without restarting the agent. In addition, configuration management is non-scalable. Also, the present limited options for configuration management of Otel agent 200 do not enable the agent to obtain dynamic configuration parameters from a remote server using, for example, the Open Agent Management Protocol (OpAMP). Further, with current agent implementations it is difficult to send/set sensitive configuration data. And, further still, current implementations of an Open Telemetry agent do not announce or make notification of whether the configuration on the agent has changed.

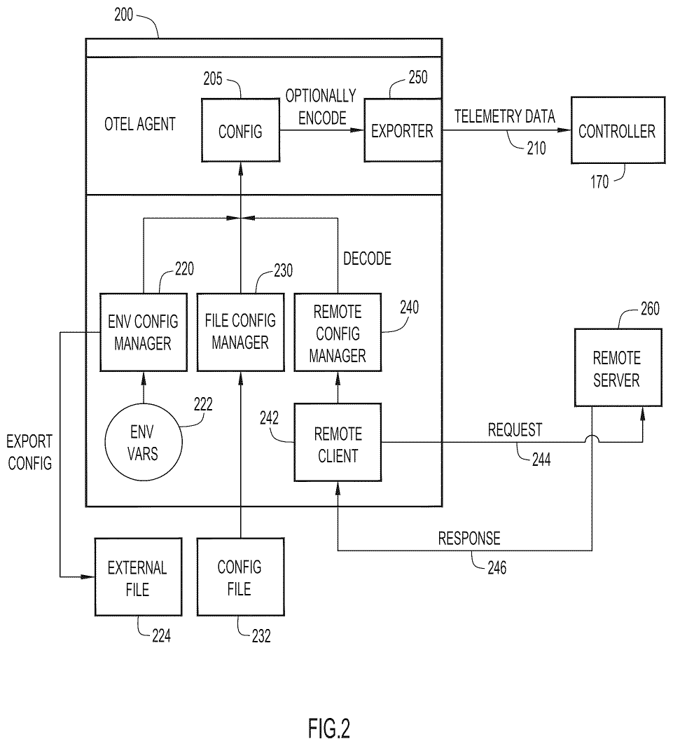

To address the foregoing, the embodiments described herein provide a more flexible agent architecture, which may be particularly suited to an Otel agent 200. Specifically, the embodiments enable a user to provide configuration data from multiple sources including remote services, as well as to provide sensitive configuration parameters. Reference is now made to FIG. 2, which shows an architecture for a telemetry agent, such as Otel agent 200, according to an example embodiment. As shown, Otel agent 200 includes a configuration module, or configuration object 205, on which operations of the Otel agent 200 are based. For example, the configuration object 205 might define which predetermined data from a host should be extracted, how often such data should be extracted, and to what destination the extracted data (telemetry data 210) should be sent. The destination may be defined by a network address, such an IP address or Uniform Resource Locator (URL).

In accordance with an embodiment, multiple configuration managers may be provided to enable configuration data or parameters to be received via multiple avenues. In the example shown in FIG. 2, an environmental configuration manager (ENV Config Manager 220), a file configuration manager (File Config Manager 230), and a remote configuration manager (Remote Config Manager 240) are provided. ENV Config Manager 220 is configured to receive environmental variables 222 (ENV VARS), to supply the same to configuration object 205, and to export the configuration supplied thereto to an external file 224. Environmental variables may be locally supplied by an administrator. File Config Manager 230 is configured to receive a configuration file 232, which may have been generated separately by an administrator or other system, and to provide configuration data in configuration file 232 to configuration object 205. Finally, Remote Config Manager 240 is configured to operate with a remote client 242. Remote client 242 may be configured to make a request 244 to a remote server 260 to obtain configuration data or parameters for configuration object 205. In response, remote server 260 may send a response 246 with the requested configuration data/information/parameters. Remote client 242 may then supply the configuration data to Remote Config Manager 240, which in turn supplies the data to configuration object 205. In some instances, the configuration data received from remote server 260 may be encoded. As such, Remote Config Manager 240 may also be configured to decode the configuration data prior to supplying the same to configuration object 205.

With appropriate configuration data encoded in configuration object 205, Otel agent 200 can then execute its predetermined data extraction functions and communicate any extracted data (optionally encoded) to exporter 250, which sends telemetry data 210 to controller 170 for analysis.

The present embodiments may be implemented, in part, via a standardized specification to manage configurations consistently across all agents. For example, such a specification may comprise (1) a “Config structure” to store/hold the configuration for various components of Otel agent 200 and (2) several operations or processes that are configured to operate on, or in connection with, the Config structure.

### Config Structure

In one embodiment implemented in Python, the Config structure may be specified as:

```
struct Config {
  traces_protocol=None
  traces_exporter=None
  otlp_endpoint=None
  otlp_protocol=None
  attributes= None
  detectors=None
  .
  .
  .
  custom_config={key1=value1, key2=value2...}
}
```

As shown above, the Config structure may incorporate configuration elements for Otel agent 200 such as traces protocol and exporter type, agent protocol and desired endpoint address, as well as any user defined CustomConfig, which, as indicated, can hold a list of custom key-value pairs. The foregoing types of configuration data or information may be referred to as parameters that impact or control the operational characteristics of the Otel agent 200. That is, parameters that control operational characteristics for Otel agent 200 might include an indication of what data to extract from a given application or device, an indication of where to send extracted data, and an indication of a protocol via which the extracted data should be transmitted, etc.

### Operations

In an embodiment, the following operations may be specified.

Init_config(config_file=None): this operation initializes the configuration object 205 with configuration parameters either from environmental variables 222 or from the configuration file 232.

Set_config(config): This operation sets the configuration from the given configuration parameters. Input can be, e.g., either a hashmap or array of configuration data. This function may override any pre-existing configuration data in the configuration object 205.

Get_effective_config( )->effective_config: This operation returns the effective_config object created by merging a remote_config with pre-existing configuration data for the Otel agent 200.

Merge_config(remote_config): This operation merges a remote_config received (from remote server 260) into/with a pre-existing configuration data and creates a new effective_config.

Export_config(endpoint, export_protocol): This operation exports the configuration data to a designated external file or eligible endpoint based on the endpoint and export_protocol (e.g., http/grpc/file).

Config_update_hook(effective_config): This operation is a callback function which may be triggered when there is a change in the configuration.

Encode_config(encoding)->encoded_config: This operation encodes sensitive configuration data values using encoding mechanisms such as SHA1/SHA256.

Decode_config( )->effective_config: This operation decodes the sensitive configuration data to its original form before applying or storing it in configuration object 205.

To implement the above operations, Otel agent 200 may create a ConfigManager interface with a placeholder method for each operation mentioned above.

Otel agent 200 may also create an Object “Config” (i.e., configuration object 205), based on the Config structure, which is then used to store the effective configuration.

In an embodiment, for each new source of configuration data, there may be an implementation of a respective ConfigManager interface, e.g., ENV Config Manager 220, File Config Manager 230, Remote Config Manager 240, etc., as shown in FIG. 2.

The configuration managers may retrieve configuration data from their sources and update the configuration object 205 to create the effective configuration. For example, ENV Config Manager 220 or File Config Manager 230 may read configuration data when Otel agent 200 boots up, and may in turn update the configuration object 205.

Whenever Otel agent 200 receives dynamic configuration data from remote server 260 or service, the operations will merge the remotely-received configuration data with pre-existing configuration data in configuration object 205 to create a new effective configuration.

Otel agent 200 may be configured to trigger the “config_change_hook( )” process as soon as there is a change in the configuration object 205. This may provide an opportunity to a user to perform any additional operations, as needed/desired, based on the configuration change.

Otel agent 200, as shown in FIG. 2, may be configured to decode sensitive configuration data before storing the same in configuration object 205.

In an embodiment, Otel agent 200 may be configured to export configuration object 205 so that, for example, the same configuration data can be re-used for other agents as desired.

In the following code example, the ConfigManager interface and FileConfigManager classes are implemented to explain how the operations of the present embodiments can be applied to a telemetry agent.

```
  class ConfigManager :
    def _init_(self, environ ):
      self.config = { }
      self.init_config(environ)
    def init_config(self, environ):
      for key, value in dict(environ):
          self.set_config(key, value )
  def set_config(self, key, value):
        self.config[key] = value
  def get_config(self, key):
        return self. config.get(key)
  def merge_config(self, new_config):
        old_config = self.config
        self.config.update(new_config)
        # Call the config change hook in case of change in config
          if old_config ≠ self.config:
            self.config_change_hook(self.config)
  def encode_config(self, key):
        self.config[key] = encode(self.config[key])
  def decode_config(self, key):
        return decode(self.config[key])
  def config_change_hook(effective_config):
        print(f “config has been changed: {dict(effective_config)}”)
  class FileConfigManager(ConfigManager):
  def_init_(self, environ, file_path =None):
        super( ).init_(environ)
        config = self.from_file(file_path)
          self.merge_config(config)
  @classmethod
  def from_file(cls, file_path):
        with open(file_path, ‘r’) as f :
              config_data = json.load (f)
        return config_data
  class Span Exporter:
        def _init_(self, config ) → None :
            self.config = config
  def export(self, spans):
        self.client.export(spans, endpoint=self.config[“endpoint”], headers=
self.config[“headers” ])
```

Briefly, Class ConfigManager is a generic interface that specifies APIs for configuration management (i.e., set_config( ), get_config( ), etc.). When a user elects to provide a new source of configuration data, a new Config Manager (i.e., FileConfigManager, discussed next), which inherits the ConfigManager class attributes, can be developed to provide the proper implementation to receive configuration data from a new given location/source.

Class FileConfigManager is a sample implementation for a configuration manager for file-based configuration data that reads the configuration from the configuration file 232 and provides it to create a new effective configuration stored in configuration object 205.

Class SpanExporter may be used to export the spans to a backend specified in the effective configuration.

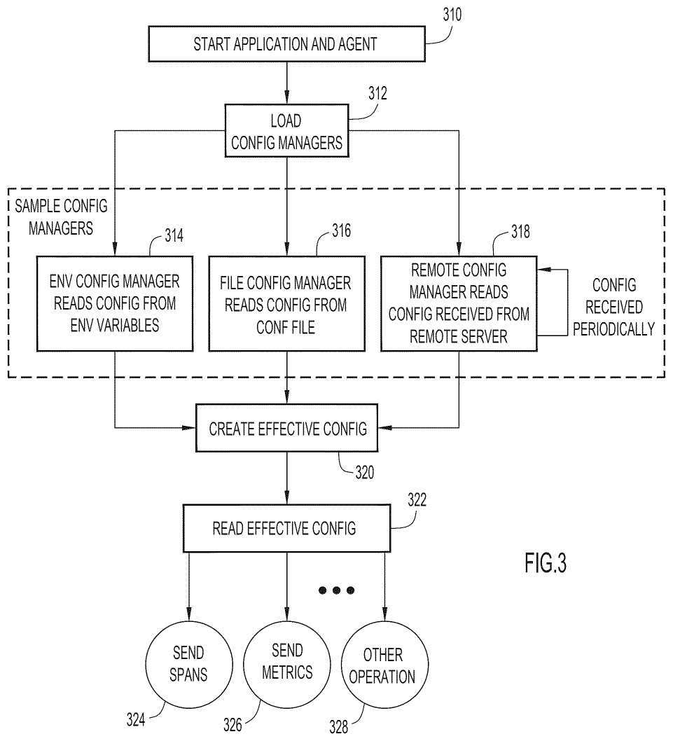

FIG. 3 is a flowchart illustrating operations of a telemetry agent that may use the specification and operations outlined above. At 310, an application hosted on a given network device 120 is started along with the agent, e.g., Otel agent 200. At 312, the agent loads available configuration managers. At 314, an operation includes reading configuration data from environmental variables. At 316, an operation includes reading configuration data from a configuration file. At 318, an operation includes reading configuration data received from a remote server. Such remote server configuration data may be supplied periodically. At 320, the agent creates an effective configuration, via, e.g., appropriate merging of configuration data from pre-existing configuration data and newly-received configuration data from one of the configuration managers. At 322, the agent reads the effective configuration, and at operations 324, 326, and 328, the agent sends spans, sends metrics, or executes other appropriate operations, respectively, given the effective configuration and results of agent operations.

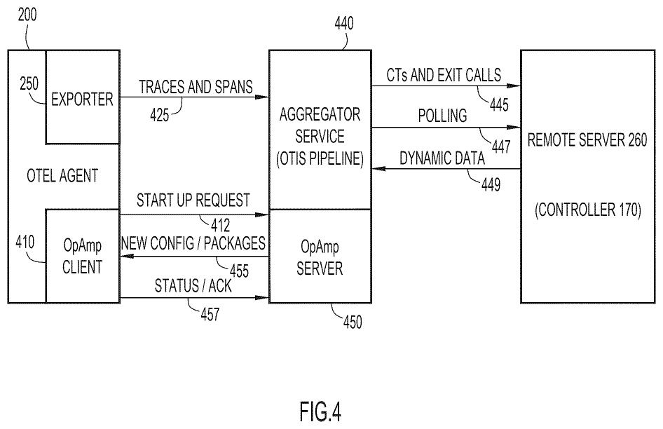

FIG. 4 shows operations that use the Open Agent Management Protocol (OpAMP) to enable an Otel agent 200 to be reconfigured from a remote server or controller, according to an example embodiment. That is, the approach of FIG. 4, as will be explained below, may be used to facilitate two-way communication between a given Otel agent 200 and a remote server 260 (as depicted in FIG. 2). As shown in FIG. 4, Otel agent 200 includes exporter 250 and an OpAMP client 410. An aggregator service 440 (or Open Telemetry Ingestion Service (OTIS)) is disposed between exporter 250 and remote server 260 or controller 170 (FIG. 2). That is, in some embodiments, remote server 260 and controller 170 could be executing as a same service and/or on a same device. Aggregator service 440 may be configured to receive traces and spans 425 (e.g., telemetry data 210) from exporter 250, and reconfigure that data into “contextual transactions” (CTs) (i.e., data reformatted to align with a particular user context) and Exit calls 445 to facilitate analysis of the traces and spans 425 by remote server 260 or controller 170.

Aggregator service 440, as shown in FIG. 4, hosts an OpAMP server 450, which is configured to communicate with OpAMP client 410. As shown, Aggregator service 440 may send polling messages 447 to remote server 260, which, in response, may send dynamic data 449, which might include updated configuration information for configuration object 205 (FIG. 2). OpAMP server 450 is configured to communicate such dynamic data 449 to OpAMP client 410 in the form of new configuration data or other packages 455. OpAMP client 410 may be configured to respond with status and/or acknowledgment messages 457.

More specifically, OpAMP client 410 is disposed on the agent side, perhaps as a sidecar, as a plugin, or fully integrated in agent code. OpAMP client 410 is configured to receive new information from OpAMP server 450 and modify the agent (i.e., Otel agent 200) accordingly. As such, Otel agent 200 can receive, via OpAMP server 450, new configuration data, (a list of) new downloadable packages, auto update capabilities, and new backend addresses to receive trace and metric data, among other possibilities.

In an embodiment, Message Protocol buffers may be employed to provide the structure to messages shared/exchanged between OpAMP client 410 and OpAMP server 450. Messages from the client side may be referred to as AgentToServer messages and messages from the server side may be referred to as ServerToAgent messages.

The following is a sequence for a configuration change from remote server 260 or controller 170 to Otel agent 200 using OpAMP. As mentioned, OpAMP client 410 is deployed with Otel agent 200 and OpAMP server 450 is deployed at aggregator service 440, e.g., at the OTIS level.

Once Otel agent 200 is started, it may send an AgentToServer startup request message 412 to OpAMP server 450. That request will be processed at aggregator service 440, which, in turn, sends a polling message 447 to remote server 260 to obtain any new configuration data/information.

The new configuration data (dynamic data 449) may be sent back to OpAMP client 410 in a ServerToAgent message. OpAMP client 410 may then process the response, merge it with pre-existing configuration data, and store a newly-generated effective configuration in configuration object 205.

If the effective configuration is different from the previous configuration, then a new AgentToServer message may be sent to aggregator service 440 to provide an update with the latest configuration. Before sending any telemetry data 210, Otel agent 200 may read the configuration data from configuration object 205 and the send/transmit the telemetry data 210 according to the new configuration (e.g., to a new backend address).

As those skilled in the art will appreciate, the approach, including the disclosed specification and operations, may help to ensure that agents follow a similar set of operations. Notably, irrespective of the source of configuration data, an agent operating in accordance with the embodiments described herein will function using the latest configuration data, even if the agent has not been restarted.

As noted, for dynamic configuration data received from a remote service, the approach may use a protocol such as OpAMP and implement an OpAMP configuration server in the backend and an OpAMP client in the agent. This enables sending configuration dynamically to the agent and, perhaps, through a RemoteConfigManager class operations as described above, such that the agent can operate with updated configuration data without have to have been restarted.

The approach of the described embodiments also supports sending confidential and sensitive configuration data from a remote service through appropriate encryption techniques. Finally, for backward compatibility, a default configuration manager (e.g., ENV Config Manager 220) may be arranged to read any configuration from environmental variables 222.

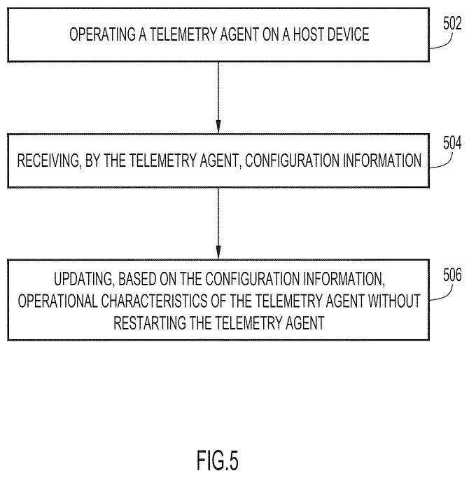

FIG. 5 is a flowchart depicting a series of steps that may be executed by the telemetry agent, according to an example embodiment. At 502, an operation includes operating the telemetry agent on a host device. At 504, an operation includes, receiving, by the telemetry agent, configuration information. And, at 506, an operation includes, updating, based on the configuration information, operational characteristics of the telemetry agent without restarting the telemetry agent. As noted throughout, the telemetry agent may be, e.g., an Open Telemetry agent.

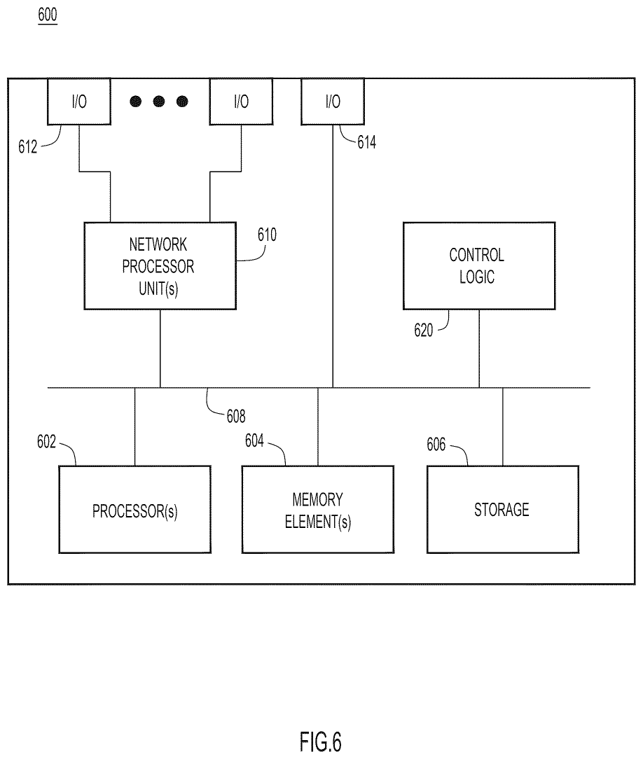

FIG. 6 is a block diagram of a computing device that may be configured to host telemetry agent logic, and to perform techniques described herein, according to an example embodiment. In various embodiments, a computing device, such as computing device 600 or any combination of computing devices 600, may be configured as any entity/entities as discussed for the techniques depicted in connection with FIGS. 1-5 in order to perform operations of the various techniques discussed herein.

In at least one embodiment, the computing device 600 may include one or more processor(s) 602, one or more memory element(s) 604, storage 606, a bus 608, one or more network processor unit(s) 610 interconnected with one or more network input/output (I/O) interface(s) 612, one or more I/O interface(s) 614, and control logic 620 (which could include the specification, and configuration object 205, described herein). In various embodiments, instructions associated with logic for computing device 600 can overlap in any manner and are not limited to the specific allocation of instructions and/or operations described herein.

In at least one embodiment, processor(s) 602 is/are at least one hardware processor configured to execute various tasks, operations and/or functions for computing device 600 as described herein according to software and/or instructions configured for computing device 600. Processor(s) 602 (e.g., a hardware processor) can execute any type of instructions associated with data to achieve the operations detailed herein. In one example, processor(s) 602 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 604 and/or storage 606 is/are configured to store data, information, software, and/or instructions associated with computing device 600, and/or logic configured for memory element(s) 604 and/or storage 606. For example, any logic described herein (e.g., control logic 620) can, in various embodiments, be stored for computing device 600 using any combination of memory element(s) 604 and/or storage 606. Note that in some embodiments, storage 606 can be consolidated with memory element(s) 604 (or vice versa) or can overlap/exist in any other suitable manner.

In at least one embodiment, bus 608 can be configured as an interface that enables one or more elements of computing device 600 to communicate in order to exchange information and/or data. Bus 608 can be implemented with any architecture designed for passing control, data and/or information between processors, memory elements/storage, peripheral devices, and/or any other hardware and/or software components that may be configured for computing device 600. In at least one embodiment, bus 608 may be implemented as a fast kernel-hosted interconnect, potentially using shared memory between processes (e.g., logic), which can enable efficient communication paths between the processes.

In various embodiments, network processor unit(s) 610 may enable communication between computing device 600 and other systems, entities, etc., via network I/O interface(s) 612 (wired and/or wireless) to facilitate operations discussed for various embodiments described herein. In various embodiments, network processor unit(s) 610 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 600 and other systems, entities, etc. to facilitate operations for various embodiments described herein. In various embodiments, network I/O interface(s) 612 can be configured as one or more Ethernet port(s), Fibre Channel ports, any other I/O port(s), and/or antenna(s)/antenna array(s) now known or hereafter developed. Thus, the network processor unit(s) 610 and/or network I/O interface(s) 612 may include suitable interfaces for receiving, transmitting, and/or otherwise communicating data and/or information in a network environment.

I/O interface(s) 614 allow for input and output of data and/or information with other entities that may be connected to computing device 600. For example, I/O interface(s) 614 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 620 can include instructions that, when executed, cause processor(s) 602 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 620) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 604 and/or storage 606 can store data, software, code, instructions (e.g., processor instructions), logic, parameters, combinations thereof, and/or the like used for operations described herein. This includes memory element(s) 604 and/or storage 606 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In sum, a method may include operating a telemetry agent on a host device, receiving, by the telemetry agent, configuration information, and updating, based on the configuration information, operational characteristics of the telemetry agent without restarting the telemetry agent.

The method may further include operating the telemetry agent operates as an Open Telemetry agent.

In the method, the operational characteristics of the telemetry agent may include at least one of extracting a predetermined type of data from the host device, sending extracted data to a predetermined endpoint address, and sending the extracted data via a predetermined protocol.

The method may further include operating, by the telemetry agent, a configuration manager that is configured to receive the configuration information as environmental variables.

The method may further include operating, by the telemetry agent, a configuration manager that is configured to receive the configuration information from a configuration file.

The method may further include operating, by the telemetry agent, a configuration manager that is configured to receive the configuration information from a remote server.

The method may further include receiving the configuration information via an Open Agent Management Protocol.

The method may further include hosting, by the telemetry agent, an Open Agent Management Protocol client via which the configuration information is received.

The method may further include, upon startup of the telemetry agent, querying the remote server for the configuration information.

The method may further include merging the configuration information with pre-existing configuration information to create a new effective configuration object, and wherein updating comprises updating, based on the new effective configuration object, the operational characteristics of the telemetry agent without restarting the telemetry agent.

In another embodiment, a device may be provided and may include an interface configured to enable network communications, a memory, and one or more processors coupled to the interface and the memory, and configured to: operate a telemetry agent on the device, receive, by the telemetry agent, configuration information, and update, based on the configuration information, operational characteristics of the telemetry agent without restarting the telemetry agent.

In the device, the telemetry agent may operate as an Open Telemetry agent.

In the device, the one or more processors may be configured to operate, by the telemetry agent, a configuration manager that is configured to receive the configuration information as environmental variables.

In the device, the one or more processors may be configured to operate, by the telemetry agent, a configuration manager that is configured to receive the configuration information from a configuration file.

In the device, the one or more processors may be configured to operate, by the telemetry agent, a configuration manager that is configured to receive the configuration information from a remote server.

In the device, the one or more processors may be configured to receive the configuration information via an Open Agent Management Protocol.

In yet another embodiment, one or more non-transitory computer readable storage media encoded with instructions are provided and that, when executed by a processor, cause the processor to: operate a telemetry agent on a host device, receive, by the telemetry agent, configuration information, and update, based on the configuration information, operational characteristics of the telemetry agent without restarting the telemetry agent.

In connection with the non-transitory computer readable storage media, the telemetry agent may operate as an Open Telemetry agent.

The instructions may be configured to operate, by the telemetry agent, a configuration manager that is configured to receive the configuration information.

The instructions may be configured to operate the configuration manager to receive the configuration information as environmental variables, from a configuration file, or from a remote server.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
operating a telemetry agent on a host device;
receiving, by the telemetry agent, configuration information; and
updating, based on the configuration information, operational characteristics of the telemetry agent without restarting the telemetry agent.

2. The method of claim 1, further comprising operating the telemetry agent operates as an Open Telemetry agent.

3. The method of claim 1, wherein the operational characteristics of the telemetry agent comprise at least one of extracting a predetermined type of data from the host device, sending extracted data to a predetermined endpoint address, and sending the extracted data via a predetermined protocol.

4. The method of claim 1, further comprising operating, by the telemetry agent, a configuration manager that is configured to receive the configuration information as environmental variables.

5. The method of claim 1, further comprising operating, by the telemetry agent, a configuration manager that is configured to receive the configuration information from a configuration file.

6. The method of claim 1, further comprising operating, by the telemetry agent, a configuration manager that is configured to receive the configuration information from a remote server.

7. The method of claim 6, further comprising receiving the configuration information via an Open Agent Management Protocol.

8. The method of claim 7, further comprising hosting, by the telemetry agent, an Open Agent Management Protocol client via which the configuration information is received.

9. The method of claim 6, further comprising, upon startup of the telemetry agent, querying the remote server for the configuration information.

10. The method of claim 1, further comprising merging the configuration information with pre-existing configuration information to create a new effective configuration object, and wherein updating comprises updating, based on the new effective configuration object, the operational characteristics of the telemetry agent without restarting the telemetry agent.

11. A device comprising:
an interface configured to enable network communications;
a memory; and
one or more processors coupled to the interface and the memory, and configured to:
operate a telemetry agent on the device;
receive, by the telemetry agent, configuration information; and
update, based on the configuration information, operational characteristics of the telemetry agent without restarting the telemetry agent.

12. The device of claim 11, wherein the telemetry agent operates as an Open Telemetry agent.

13. The device of claim 11, wherein the one or more processors are configured to operate, by the telemetry agent, a configuration manager that is configured to receive the configuration information as environmental variables.

14. The device of claim 11, wherein the one or more processors are configured to operate, by the telemetry agent, a configuration manager that is configured to receive the configuration information from a configuration file.

15. The device of claim 11, wherein the one or more processors are configured to operate, by the telemetry agent, a configuration manager that is configured to receive the configuration information from a remote server.

16. The device of claim 15, wherein the one or more processors are configured to receive the configuration information via an Open Agent Management Protocol.

17. One or more non-transitory computer readable storage media encoded with instructions that, when executed by a processor, cause the processor to:
operate a telemetry agent on a host device;
receive, by the telemetry agent, configuration information; and
update, based on the configuration information, operational characteristics of the telemetry agent without restarting the telemetry agent.

18. The one or more non-transitory computer readable storage media of claim 17, wherein the telemetry agent operates as an Open Telemetry agent.

19. The one or more non-transitory computer readable storage media of claim 17, wherein the instructions are configured to operate, by the telemetry agent, a configuration manager that is configured to receive the configuration information.

20. The one or more non-transitory computer readable storage media of claim 19, wherein the instructions are configured to operate the configuration manager to receive the configuration information as environmental variables, from a configuration file, or from a remote server.
